(19) United States
(12) Patent Application Publication
(10) Pub. No.: US 2010/0056056 A1
(43) Pub. Date: Mar. 4, 2010

(54) SYNCHRONOUS WIRELESS TRANSMISSION SYSTEM AND SYNCHRONOUS WIRELESS TRANSMISSION METHOD

(75) Inventors: Chien-Nan Lin, Taipei (TW); Chin-Lung Lai, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/260,526

(22) Filed: Oct. 29, 2008

(30) Foreign Application Priority Data
Aug. 29, 2008 (TW) 097133050

(51) Int. Cl. H04B 7/00

(52) U.S. Cl. 455/41.3

(57) ABSTRACT

A synchronous wireless transmission method is used in a synchronous wireless transmission system including a first wireless device for generating a wireless signal, a second wireless device for generating a second wireless signal, and a wireless signal receiver for receiving the first and second wireless signals. The wireless signal receiver receives the first wireless signal in the first receipt time segment and the second wireless signal in the second receipt time segment. When the first or second wireless signal is received, the wireless signal receiver issues a responding signal to the first or second wireless device. According to the responding signal, the first and second wireless device determines whether the time of issuing the first or second wireless signal to the wireless signal receiver is adjusted.

### FIELD OF THE INVENTION

The present invention relates to a wireless transmission system, and more particularly to a synchronous wireless transmission system for synchronously transmitting data.

### BACKGROUND OF THE INVENTION

With rapid development of scientific and information industries, computers and the peripheral devices thereof become essential in our daily lives. Conventionally, a computer host and the peripheral devices thereof are communicated with each other via wire linkage. Although the processes of storing or managing the connecting wires are not serious problems, the wire linkage is somewhat troublesome. In addition, if the connecting wires between the computer host and the peripheral devices thereof are very long, the wire linkage becomes inconvenient. For solving these drawbacks, wireless peripheral devices are developed to be communicated with the computer host according to a wireless transmission technology. The wireless peripheral devices include for example wireless mice, wireless earphones, wireless keyboards and the like.

Take a computer system as a wireless transmission system for example. FIG. 1 is a schematic view illustrating the architecture of a conventional wireless transmission system. The wireless transmission system of FIG. 1 is a computer system. As shown in FIG. 1, the computer system 10 comprises a computer host 100, a wireless mouse 110 and a wireless keyboard 120. A wireless signal receiver 130 is connected to the computer host 100. The wireless mouse 110 has a wireless mouse control unit 111. The wireless keyboard 120 has a wireless keyboard control unit 121. Under control of the wireless mouse control unit 111, the wireless mouse 110 issues a mouse wireless signal WS11 to the wireless signal receiver 130. Under control of the wireless keyboard control unit 121, the wireless keyboard 120 issues a keyboard wireless signal WS12 to the wireless signal receiver 130. In response to the mouse wireless signal WS11 and the keyboard wireless signal WS12, the computer host 100 executes corresponding functions. In a case that only the wireless mouse 110 is operated, the wireless mouse 110 generates the mouse wireless signal WS11 to the wireless signal receiver 130. In response to the mouse wireless signal WS11, the computer host 100 executes a corresponding function. In another case that the wireless mouse 110 and the wireless keyboard 120 are simultaneously operated, the mouse wireless signal WS11 issued by the wireless mouse 110 and the keyboard wireless signal WS12 issued by the wireless keyboard 120 are possibly transmitted to the wireless signal receiver 130 at the same time. Under this circumstance, a so-call data collision problem occurs between the mouse wireless signal WS11 and the keyboard wireless signal WS12. Due to occurrence of the data collision problem, the wireless signal receiver 130 fails to successfully receive either or both of the mouse wireless signal WS11 and the keyboard wireless signal WS12. For continuously performing wireless transmission when the data collision problem occurs, a synchronous wireless transmission system has been proposed.

FIG. 2 schematically illustrates timing of the related signals processed in a conventional synchronous wireless transmission system. The synchronous wireless transmission system has architecture similar to that shown in FIG. 1. In FIG. 2, three clock diagrams CLK130, CLK110 and CLK120 are shown. The clock diagram CLK130 indicates the action of the wireless signal receiver 130. The clock diagram CLK110 indicates the action of the wireless mouse 110. The clock diagram CLK120 indicates the action of the wireless keyboard 120. In the computer system 10, the wireless signal receiver 130 that is connected to the computer host 100 will continuously and periodically generate data detection signals DS1˜DS4 to the wireless mouse 110 and the wireless keyboard 120. In response to the data detection signals DS1˜DS4, the wireless mouse 110 will issue the mouse wireless signal WS11 or the wireless keyboard 120 will issue the keyboard wireless signal WS12.

Please refer to FIGS. 1 and 2 again. The wireless signal receiver 130 generates a data detection signal in each detecting time segment Td. After a receipt time period Tr, a next data detection signal is generated. In accordance with a predetermined programming, the odd-numbered data detection signals DS1, DS3, . . . are allocated to be received by the wireless mouse 110 but the even-numbered data detection signals DS2, DS4, . . . are allocated to be received by the wireless keyboard 120. On the other hand, when the wireless mouse 110 is operated by the user and generates mouse operating data, the wireless mouse control unit 111 fails to realize whether the wireless signal receiver 130 is receiving signals from other wireless peripheral devices or not. Under this circumstance, the wireless mouse control unit 111 will enter a wait mode RX. In the wait mode RX, the wireless mouse 110 will wait for the data detection signals that are transmitted from the wireless signal receiver 130. Once the data detection signals are generated, the wireless mouse 110 begins to receive the data detection signals. For example, when the wireless mouse 110 receives the first data detection signal DS1 that is allocated to the wireless mouse 110, the wireless mouse control unit 111 will control the wireless mouse 110 to issue the mouse wireless signal WS11 to the wireless signal receiver 130 so as to transmit the mouse operating data. Whereas, when the wireless mouse control unit 111 enters the wait mode RX and the wireless mouse 110 waits for and receives the second data detection signal DS2 that is not allocated to the wireless mouse 110, the wireless mouse 110 does not respond to the second data detection signal DS2 but the wireless mouse control unit 111 is maintained in the wait mode RX. Until the wireless mouse 110 receives the third data detection signal DS3 that is allocated to the wireless mouse 110, the wireless mouse control unit 111 will control the wireless mouse 110 to issue the mouse wireless signal WS11 to the wireless signal receiver 130.

Similarly, when the wireless keyboard control unit 121 enters the wait mode RX and the wireless keyboard 120 receives the first data detection signal DS1 that is not allocated to the wireless keyboard 120, the wireless keyboard 120 does not respond to the first data detection signal DS1 but the wireless keyboard control unit 121 is maintained in the wait mode RX. Until the wireless keyboard 120 receives the second data detection signal DS2, the wireless keyboard control unit 121 will control the wireless keyboard 120 to issue the keyboard wireless signal WS12 to the wireless signal receiver 130, as can be seen in FIG. 2. Subsequently, the wireless signal receiver 130 generates the data detection signals DS1˜DS4 in each detecting time segment Td. In a case that only the wireless mouse 110 is used but the wireless keyboard 120 is not in use, the wireless keyboard 120 needs not perform wireless data transmission and thus the wireless keyboard control unit 121 will not enter the wait mode RX. When the third data detection signal DS3 that is allocated to the wireless keyboard 120 is received by the wireless keyboard 120, the wireless keyboard 120 does not respond to the third data detection signal DS3. Next, the fourth data detection signal DS4 issued by the wireless signal receiver 130 is received by the wireless keyboard 120. At this moment, the wireless keyboard 120 needs not perform wireless data transmission and the wireless keyboard control unit 121 needs not to enter the wait mode RX. Consequently, the wireless keyboard 120 does not respond to the fourth data detection signal DS4.

From the above discussion, the conventional synchronous wireless transmission system is effective for preventing data collision by entering the waiting mode and allocating the data detection signals. The conventional synchronous wireless transmission system, however, still has some drawbacks. For example, the wireless peripheral devices in the waiting mode will consume much electricity. Especially when the wireless peripheral devices have maintained in the waiting mode for a long time period, the power consumption of the wireless peripheral devices become more rapid. Moreover, since the wireless peripheral devices are wirelessly communicated with the computer host, the wireless peripheral devices fail to acquire electricity from the connecting ports of the computer host. As such, it is necessary to mount a battery in each wireless peripheral device in order to provide electricity for operating the wireless peripheral device. In researching the synchronous wireless transmission system, it is critical to extend the use time of the battery by reducing power consumption of the wireless peripheral device.

### SUMMARY OF THE INVENTION

The present invention provides a synchronous wireless transmission system and a synchronous wireless transmission method in order to reduce power consumption.

In accordance with an aspect of the present invention, there is provided a synchronous wireless transmission method for use in a synchronous wireless transmission system. The synchronous wireless transmission system includes a first wireless device, a second wireless device and a wireless signal receiver connected to a computer host. The first wireless device generates a first wireless signal to the wireless signal receiver. The second wireless device generates a second wireless signal to the wireless signal receiver. The wireless signal receiver receives the first and second wireless signals. The synchronous wireless transmission method includes the following steps. Firstly, the wireless signal receiver generates a receiver detection signal including a detecting time segment and a receipt time period, and issues a data detection signal and a time segment reporting signal during the detecting time segment. The receipt time period includes a first receipt time segment and a second receipt time segment. The first wireless signal is received in the first receipt time segment. The second wireless signal is received in the second receipt time segment. When the first or second wireless signal is received by the wireless signal receiver, the wireless signal receiver issues a responding signal including the time segment report signal and a receipt confirming signal to the first or second wireless device during the receipt time period. Then, it is discriminated whether the first wireless signal is received during the first receipt time segment by the first wireless device or the second wireless signal is received during the second receipt time segment by the second wireless device according to the time segment reporting signal. If the first wireless signal is received during the first receipt time segment or the second wireless signal is received during the second receipt time segment, the first or second wireless signal is continuously generated. If the first wireless signal is not received during the first receipt time segment or the second wireless signal is not received during the second receipt time segment, the time of generating the first or second wireless signal is adjusted according to the time segment reporting signal.

In an embodiment, the first wireless device enters a waiting mode when the first wireless device issues the first wireless signal to the wireless signal receiver but the receipt confirming signal has not been received by the first wireless device. The first wireless device further issues the first wireless signal to the wireless signal receiver again when the data detection signal and the time segment reporting signal are received by the first wireless device.

In an embodiment, the second wireless device enters a waiting mode when the second wireless device issues the second wireless signal to the wireless signal receiver but the receipt confirming signal has not been received by the second wireless device. The second wireless device further issues the second wireless signal to the wireless signal receiver again when the data detection signal and the time segment reporting signal are received by the second wireless device.

In an embodiment, the first wireless device and the second wireless device are computer peripheral devices.

In accordance with another aspect of the present invention, there is provided a synchronous wireless transmission system. The synchronous wireless transmission system includes a first wireless device, a second wireless device and a wireless signal receiver. The first wireless device is used for generating a first wireless signal ad includes a first wireless device control unit. The second wireless device is used for generating a second wireless signal, and includes a second wireless device control unit. The wireless signal receiver is connected to a computer host for generating a receiver detection signal and receiving the first and second wireless signals. The receiver detection signal includes a detecting time segment and a receipt time period. The wireless signal receiver includes a receiver control unit for controlling the wireless signal receiver to issue a data detection signal and a time segment reporting signal during the detecting time segment. The wireless signal receiver issues a responding signal including the time segment report signal and a receipt confirming signal to the first or second wireless device when the first or second wireless signal is received by the wireless signal receiver during the receipt time period. The receipt time period includes a first receipt time segment and a second receipt time segment. The first wireless signal is received in the first receipt time segment. The second wireless signal is received in the second receipt time segment. If the first wireless signal is received during the first receipt time segment or the second wireless signal is received during the second receipt time segment, the first or second wireless device control unit controls the first or second wireless device to continuously generate the first or second wireless signal. If the first wireless signal is not received by the wireless signal receiver during the first receipt time segment or the second wireless signal is not received by the wireless signal receiver during the second receipt time segment, the first or second wireless device control unit adjusts the time of generating the first or second wireless signal according to the time segment reporting signal.

In an embodiment, the first wireless device enters a waiting mode when the first wireless device issues the first wireless signal to the wireless signal receiver but the receipt confirming signal has not been received by the first wireless device. The first wireless device further issues the first wireless signal to the wireless signal receiver again when the data detection signal and the time segment reporting signal are received by the first wireless device.

In an embodiment, the second wireless device enters a waiting mode when the second wireless device issues the second wireless signal to the wireless signal receiver but the receipt confirming signal has not been received by the second wireless device. The second wireless device further issues the second wireless signal to the wireless signal receiver again when the data detection signal and the time segment reporting signal are received by the second wireless device.

In an embodiment, the first wireless device and the second wireless device are computer peripheral devices.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the architecture of a conventional wireless transmission system;

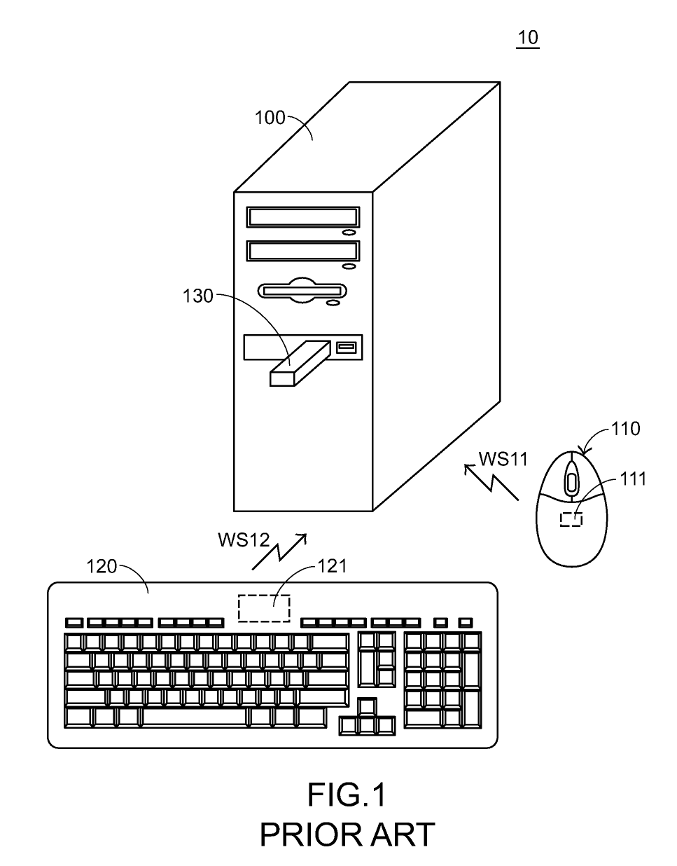

FIG. 2 schematically illustrates timing of the related signals processed in a conventional synchronous wireless transmission system;

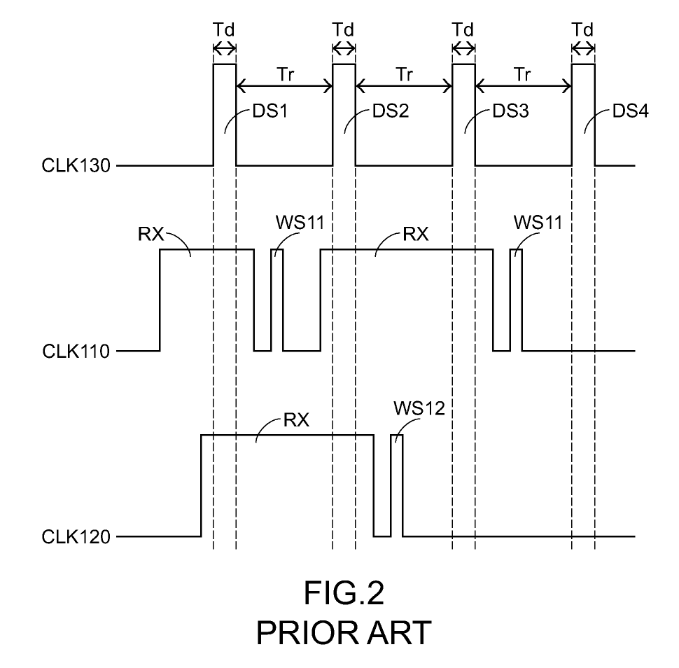

FIG. 3 is a schematic view illustrating the architecture of a synchronous wireless transmission system according to the present invention;

FIG. 4 schematically illustrates timing of the related signals processed in the synchronous wireless transmission system according to an embodiment of the present invention; and

FIG. 5 schematically illustrates timing of the related signals processed in the synchronous wireless transmission system according to another embodiment of the present invention.

### DETAILED DESCRIPTION OF THE PREFERRED EMBODIMENT

As previously described, the conventional synchronous wireless transmission method consumes much electricity. For obviating the drawbacks encountered from the prior art, the present invention provides a synchronous wireless transmission system.

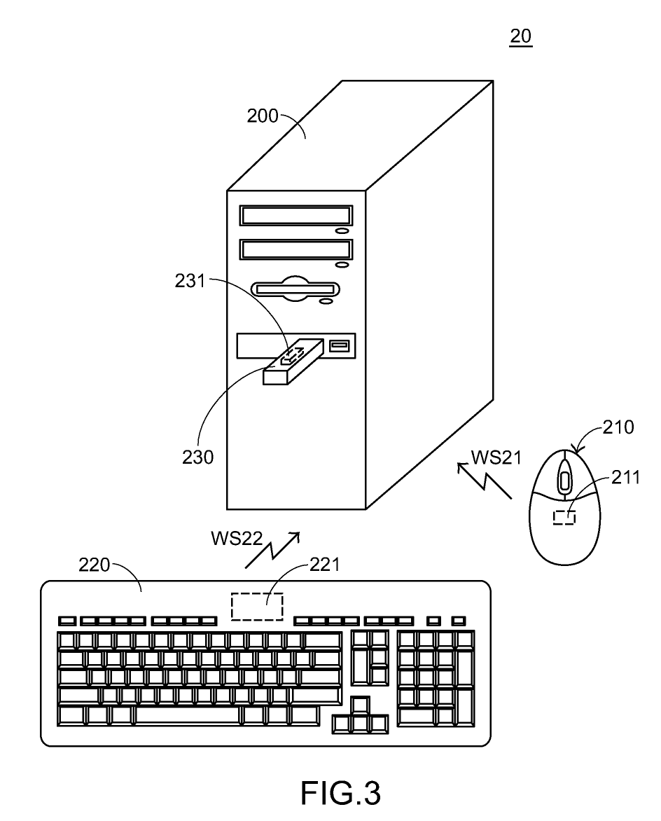

FIG. 3 is a schematic view illustrating the architecture of a synchronous wireless transmission system according to the present invention. In FIG. 3, a computer system is used as an exemplary synchronous wireless transmission system for illustration. As shown in FIG. 3, the computer system 20 comprises a computer host 200, a wireless mouse 210 and a wireless keyboard 220. A wireless signal receiver 230 is connected to the computer host 200. The wireless signal receiver 230 has a receiver control unit 231. The wireless mouse 210 has a wireless mouse control unit 211. The wireless keyboard 220 has a wireless keyboard control unit 221. Under control of the wireless mouse control unit 211, the wireless mouse 210 issues a mouse wireless signal WS21 to the wireless signal receiver 230. Under control of the wireless keyboard control unit 221, the wireless keyboard 220 issues a keyboard wireless signal WS22 to the wireless signal receiver 230. In response to the mouse wireless signal WS21 and the keyboard wireless signal WS22, the computer host 200 executes corresponding functions.

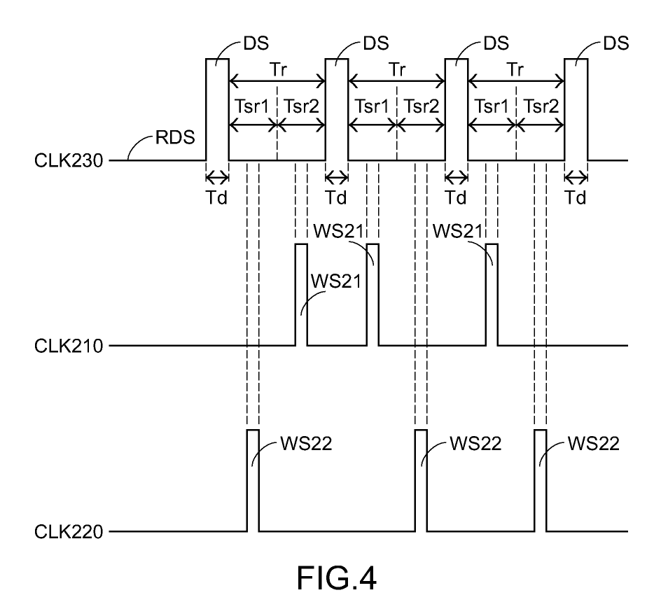

FIG. 4 schematically illustrates timing of the related signals processed in the synchronous wireless transmission system according to an embodiment of the present invention. In FIG. 4, three clock diagrams CLK230, CLK210 and CLK220 are shown. The clock diagram CLK230 indicates the action of the wireless signal receiver 230. The clock diagram CLK210 indicates the action of the wireless mouse 210. The clock diagram CLK220 indicates the action of the wireless keyboard 220. Please refer to FIGS. 3 and 4. In the computer system 20, the wireless signal receiver 230 that is connected to the computer host 200 will continuously and periodically generate receiver detection signals RDS to the wireless mouse 210 and the wireless keyboard 220. Each cycle of the receiver detection signals RDS includes a detecting time segment Td and a receipt time period Tr. The wireless signal receiver 230 generates a data detection signal DS and a time segment reporting signal (not shown) in each detecting time segment Td. During the receipt time period Tr, the wireless signal receiver 230 receives the mouse wireless signal WS21 and the keyboard wireless signal WS22 and issues a responding signal (not shown) including the time segment report signal (not shown) and a receipt confirming signal (not shown) to the wireless mouse 210 or the wireless keyboard 220. The receipt time period Tr includes a first receipt time segment Tsr1 and a second receipt time segment Tsr2. The wireless signal receiver 230 receives the mouse wireless signal WS21 and the keyboard wireless signal WS22 during the first receipt time segment Tsr1 and the second receipt time segment Tsr2, respectively. In accordance with a key feature of the present invention, the data detection signals DS are not exclusively allocated to the wireless mouse 210 or the wireless keyboard 220. In addition, the data detection signals DS can be received by the wireless peripheral devices such as the wireless mouse 210 and the wireless keyboard 220 that are in the waiting mode RX.

For preventing data collision during the synchronous wireless transmission, according to a predetermined programming, the wireless mouse control unit 211 will control the wireless mouse 210 to generate the mouse wireless signal WS21 during a preset first receipt time segment, and the wireless keyboard control unit 221 will control the wireless keyboard 220 to generate the keyboard wireless signal WS22 during a preset second receipt time segment.

In the initial stage, before the wireless mouse 210 and the wireless keyboard 220 are communicated with the wireless signal receiver 230, the wireless mouse 210 fails to realize whether there is a time difference between the preset first receipt time segment of the wireless mouse control unit 211 and the first receipt time segment Tsr1 of the wireless signal receiver 230. Similarly, before the wireless mouse 210 and the wireless keyboard 220 are communicated with the wireless signal receiver 230, the wireless keyboard 220 fails to realize whether there is a time difference between the preset second receipt time segment of the wireless keyboard control unit 221 and the second receipt time segment Tsr2 of the wireless signal receiver 230. In other words, the wireless mouse 210 and the wireless keyboard 220 fail to realize whether the occurrence of the mouse wireless signal WS21 and the keyboard wireless signal WS22 comply with the first receipt time segment Tsr1 and the second receipt time segment Tsr2, respectively.

Since the wireless mouse 210 fails to realize whether the preset first receipt time segment of the wireless mouse control unit 211 complies with the first receipt time segment Tsr1, the wireless mouse 210 generates the mouse wireless signal WS21 during the preset first receipt time segment. Moreover, the wireless signal receiver 230 generates a receipt confirming signal to confirm whether the preset first receipt time segment is deviated from the first receipt time segment Tsr1. Likewise, the wireless keyboard 220 generates the keyboard wireless signal WS22 and the wireless signal receiver 230 generates a receipt confirming signal to confirm whether the preset second receipt time segment is deviated from the second receipt time segment Tsr2.

Please refer to FIGS. 3 and 4 again. The wireless keyboard 220 generates the keyboard wireless signal WS22 during the preset second receipt time segment of the wireless keyboard control unit 221. The wireless mouse 210 generates the mouse wireless signal WS21 during the preset first receipt time segment of the wireless mouse control unit 211. As shown in FIG. 4, the second receipt time segment of the wireless keyboard control unit 221 lies within the first receipt time segment Tsr1 of the receipt time period Tr, and the preset first receipt time segment of the wireless mouse control unit 211 lies within the second receipt time segment Tsr2 of the receipt time period Tr. In other words, the preset first receipt time segment and the preset first receipt time segment are deviated from the first receipt time segment Tsr1 and the second receipt time segment Tsr2, respectively. For correcting the time deviation between the preset first receipt time segment and the first receipt time segment Tsr1 and the time deviation between the preset second receipt time segment and the second receipt time segment Tsr2, the receiver control unit 231 of the wireless signal receiver 230 will generate the responding signal. When the mouse wireless signal WS21 or the keyboard wireless signal WS22 is received by the wireless signal receiver 230, the responding signal is transmitted to the wireless mouse 210 or the wireless keyboard 220. As mentioned above, the responding signal includes the time segment report signal and the receipt confirming signal. In response to the receipt confirming signal, the wireless mouse 210 or the wireless keyboard 220 will confirm that the mouse wireless signal WS21 or the keyboard wireless signal WS22 is received by the wireless signal receiver 230. In response to the time segment report signal, the wireless mouse 210 or the wireless keyboard 220 will realize that the mouse wireless signal WS21 is received by the wireless signal receiver 230 during the first receipt time segment Tsr1 and the keyboard wireless signal WS22 is received by the wireless signal receiver 230 during the second receipt time segment Tsr2. When the responding signal is received by the wireless mouse 210, the wireless mouse control unit 211 realizes that the mouse wireless signal WS21 has been successfully transmitted and the preset first receipt time segment is deviated from the first receipt time segment Tsr1 (that is, the preset first receipt time segment lies within the second receipt time segment Tsr2). As such, the mouse control unit 211 will calculate the time difference between the preset first receipt time segment and the first receipt time segment Tsr1, and adjust the preset first receipt time segment until the preset first receipt time segment and the first receipt time segment Tsr1 are synchronous. Likewise, when the responding signal is received by the wireless keyboard 220, the wireless keyboard control unit 221 will calculate the time difference between the preset second receipt time segment and the second receipt time segment Tsr2, and adjust the preset second receipt time segment until the preset second receipt time segment and the second receipt time segment Tsr2 are synchronous. Under this circumstance, the time of issuing data by the wireless mouse 210 and the time of issuing data by the wireless keyboard 220 are separated from each other, thereby preventing data collision. For preventing the time deviations of the preset first receipt time segment and the preset second receipt time segment, the wireless signal receiver 230 will issue the responding signal as long as the first or second wireless signal is received. According to the time segment reporting signals included in the responding signals, the wireless mouse control unit 211 and the wireless mouse control unit 211 can realize whether there is any time deviation. If there any time deviation, the time of generating the mouse wireless signal or the keyboard wireless signal is adjusted such that the preset receipt time segments of the wireless mouse and the wireless keyboard are synchronized.

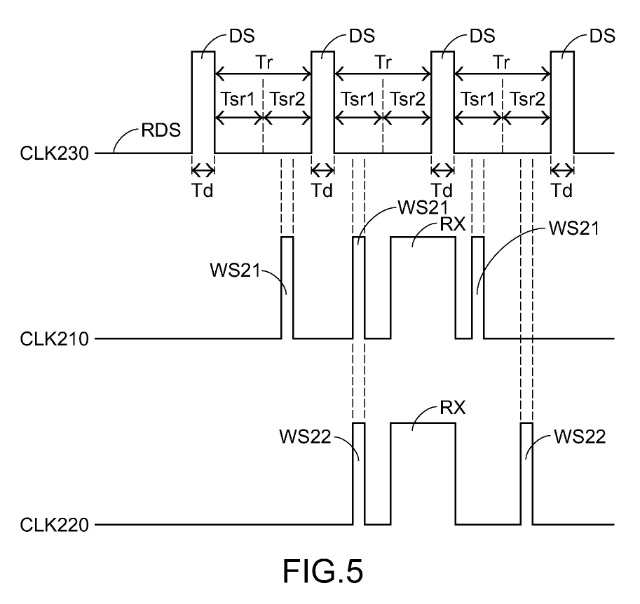

In the embodiment of FIG. 4, since the preset first and second receipt time segments do not comply with the practical first and second receipt time segments Tsr1 and Tsr2. In addition, no data collision occurs in the synchronous wireless transmission system of FIG. 4. Hereinafter, a method of solving the data collision by the synchronous wireless transmission system of the present invention will be illustrated with reference to FIG. 5. FIG. 5 schematically illustrates timing of the related signals processed in the synchronous wireless transmission system according to another embodiment of the present invention. The synchronous wireless transmission system of this embodiment is similar to that shown in FIG. 4, and is not redundantly described herein. In this embodiment, the time of generating the keyboard wireless signal WS22 is distinguished from that of FIG. 4.

Please refer to FIG. 5. First of all, the wireless mouse 210 generates the mouse wireless signal WS21 during the preset first receipt time segment of the wireless mouse control unit 211 but the wireless mouse 210 takes no action. When the mouse wireless signal WS21 is received by the wireless signal receiver 230, the wireless signal receiver 230 issues a responding signal When the responding signal is received by the wireless mouse 210, the wireless mouse control unit 211 realizes that the mouse wireless signal WS21 has been successfully transmitted and the preset first receipt time segment is deviated from the first receipt time segment Tsr1 (that is, the preset first receipt time segment lies within the second receipt time segment Tsr2). As such, the mouse control unit 211 will calculate the time difference between the preset first receipt time segment and the first receipt time segment Tsr1, and adjust the preset first receipt time segment until the preset first receipt time segment and the first receipt time segment Tsr1 are synchronous. Then, the wireless mouse 210 generates the next mouse wireless signal WS21 during the corrected preset first receipt time segment that is synchronous with the first receipt time segment Tsr1. At the moment, the wireless keyboard 220 issues the keyboard wireless signal WS22. Since the second receipt time segment of the wireless keyboard control unit 221 lies within the first receipt time segment Tsr1, the data collision problem occurs between the mouse wireless signal WS21 and the keyboard wireless signal WS22. Under this circumstance, the wireless signal receiver 230 fails to successfully receive either or both of the mouse wireless signal WS21 and the keyboard wireless signal WS22.

When the data collision problem occurs, the mouse control unit 211 and the wireless keyboard control unit 221 enter a wait mode RX. In the wait mode RX, the wireless mouse 210 and the wireless keyboard 220 will wait for the data detection signal DS and the time segment reporting signal that are transmitted from the wireless signal receiver 230. Subsequently, the data detection signal DS and the time segment reporting signal are received by the wireless mouse 210 and the wireless keyboard 220. According to the time segment reporting signal, the wireless mouse 210 or the wireless keyboard 220 will determine the time difference between the wireless signal receiver 230 and the wireless mouse 210 or the wireless keyboard 220 by referring to the detecting time segment Td. After the time segment reporting signal is received by the wireless mouse 210 and the wireless keyboard 220, the preset first receipt time segment and the preset second receipt time segment are adjusted to be synchronously with the first receipt time segment Tsr1 and the second receipt time segment Tsr2, respectively. As a consequence, the wireless mouse 210 will generate the mouse wireless signal WS21 during the adjusted time segment that complies with the first receipt time segment Tsr1; and the wireless keyboard 220 will generate the keyboard wireless signal WS22 during the adjusted time segment that complies with the second receipt time segment Tsr2.

From the above description, the wireless devices of the synchronous wireless transmission system of the present invention issue corresponding wireless signals in different preset receipt time segments, so that no data collision problem occurs between these wireless devices. In the initial stage, since the first wireless device, the second wireless device and the wireless signal receiver are separate device without communication between each other, the first and second wireless devices generate first and second wireless signals during self-selected time segments. After the wireless signal issued by the first or second wireless device is received by the wireless signal receiver, the wireless signal receiver issues a responding signal. According to the time segment reporting signal included in the responding signal, the first or second wireless device will realize the time segment when the wireless signal is received by the wireless signal receiver. The time deviation is adjusted such that the adjusted time segment of the wireless device is synchronously with the time segment of the wireless signal receiver. Under this circumstance, the data collision problem is solved.

In the embodiment of FIG. 4, the wireless device needs not enter the waiting mode and the wireless device consumes electricity only during the process of issuing the wireless signal. In the embodiment of FIG. 5, the wireless device needs to enter the waiting mode for one time during the synchronous wireless transmission. Since the data detection signals are continuously generated without being exclusively allocated to specified wireless device, the data detection signals can be received by all wireless devices that are in the receiving mode. Since the time segment in the receiving mode is shorter than the detecting time segment of the wireless signal receiver, the power consumption of the synchronous wireless transmission method of the present invention is largely reduced in comparison with the prior art. Moreover, since the data collision problem is solved, the data transmission efficiency of the synchronous wireless transmission method is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A synchronous wireless transmission method for use in a synchronous wireless transmission system, said synchronous wireless transmission system comprising a first wireless device, a second wireless device and a wireless signal receiver connected to a computer host, said first wireless device generating a first wireless signal to said wireless signal receiver, said second wireless device generating a second wireless signal to said wireless signal receiver, and said wireless signal receiver receiving said first and second wireless signals, said synchronous wireless transmission method comprising steps of:
said wireless signal receiver generating a receiver detection signal including a detecting time segment and a receipt time period, and issuing a data detection signal and a time segment reporting signal during said detecting time segment, said receipt time period including a first receipt time segment and a second receipt time segment, wherein said first wireless signal is received in said first receipt time segment, said second wireless signal is received in said second receipt time segment, and when said first or second wireless signal is received by said wireless signal receiver, said wireless signal receiver issues a responding signal including said time segment report signal and a receipt confirming signal to said first or second wireless device during said receipt time period;
discriminating whether said first wireless signal is received during said first receipt time segment by said first wireless device or said second wireless signal is received during said second receipt time segment by said second wireless device according to said time segment reporting signal;
continuously generating said first or second wireless signal if said first wireless signal is received during said first receipt time segment or said second wireless signal is received during said second receipt time segment; and
adjusting the time of generating said first or second wireless signal according to said time segment reporting signal if said first wireless signal is not received during said first receipt time segment or said second wireless signal is not received during said second receipt time segment.

2. The synchronous wireless transmission method according to claim 1 wherein said first wireless device enters a waiting mode when said first wireless device issues said first wireless signal to said wireless signal receiver but said receipt confirming signal has not been received by said first wireless device, and said first wireless device further issues said first wireless signal to said wireless signal receiver again when said data detection signal and said time segment reporting signal are received by said first wireless device.

3. The synchronous wireless transmission method according to claim 1 wherein said second wireless device enters a waiting mode when said second wireless device issues said second wireless signal to said wireless signal receiver but said receipt confirming signal has not been received by said second wireless device, and said second wireless device further issues said second wireless signal to said wireless signal receiver again when said data detection signal and said time segment reporting signal are received by said second wireless device.

4. The synchronous wireless transmission method according to claim 1 wherein said first wireless device and said second wireless device are computer peripheral devices.

5. A synchronous wireless transmission system, comprising:
a first wireless device for generating a first wireless signal, said first wireless device including a first wireless device control unit;
a second wireless device for generating a second wireless signal, said second wireless device including a second wireless device control unit; and
a wireless signal receiver connected to a computer host for generating a receiver detection signal and receiving said first and second wireless signals, said receiver detection signal including a detecting time segment and a receipt time period, said wireless signal receiver including a receiver control unit for controlling said wireless signal receiver to issue a data detection signal and a time segment reporting signal during said detecting time segment, and said wireless signal receiver issuing a responding signal including said time segment report signal and a receipt confirming signal to said first or second wireless device when said first or second wireless signal is received by said wireless signal receiver during said receipt time period, wherein said receipt time period including a first receipt time segment and a second receipt time segment, said first wireless signal is received in said first receipt time segment, and said second wireless signal is received in said second receipt time segment,
wherein said first or second wireless device control unit controls said first or second wireless device to continuously generate said first or second wireless signal if said first wireless signal is received during said first receipt time segment or said second wireless signal is received during said second receipt time segment, and said first or second wireless device control unit adjusts the time of generating said first or second wireless signal according to said time segment reporting signal if said first wireless signal is not received by said wireless signal receiver during said first receipt time segment or said second wireless signal is not received by said wireless signal receiver during said second receipt time segment.

6. The synchronous wireless transmission system according to claim 5 wherein said first wireless device enters a waiting mode when said first wireless device issues said first wireless signal to said wireless signal receiver but said receipt confirming signal has not been received by said first wireless device, and said first wireless device further issues said first wireless signal to said wireless signal receiver again when said data detection signal and said time segment reporting signal are received by said first wireless device.

7. The synchronous wireless transmission system according to claim 5 wherein said second wireless device enters a waiting mode when said second wireless device issues said second wireless signal to said wireless signal receiver but said receipt confirming signal has not been received by said second wireless device, and said second wireless device further issues said second wireless signal to said wireless signal receiver again when said data detection signal and said time segment reporting signal are received by said second wireless device.

8. The synchronous wireless transmission system according to claim 5 wherein said first wireless device and said second wireless device are computer peripheral devices.
